(19) United States
(12) Patent Application Publication
(10) Pub. No.: US 2026/0141149 A1
(43) Pub. Date: May 21, 2026

(54) LOW NOISE FPGA CLOCK SYSTEMS AND METHODS

(71) Applicant: Lattice Semiconductor Corporation, Hillsboro, OR (US)

(72) Inventor: Bradley A. Sharpe-Geisler, San Jose, CA (US)

(21) Appl. No.: 18/949,869

(22) Filed: Nov. 15, 2024

(51) Int. Cl. G06F 30/347; G06F 117/04

(52) U.S. Cl. CPC G06F 30/347; G06F 2117/04

(57) ABSTRACT

Various techniques are provided to efficiently synchronize clock and data signals in programmable logic devices (PLDs). A method includes configuring a programmable logic device (PLD) having a fabric of programmable logic blocks arranged in a plurality of regions; routing data carry chains in a first direction across the fabric to each of the plurality of regions; placing global clock circuitry at a first edge of the PLD; and routing the global clock to a corresponding first edge of each region via a global clock trunk and a plurality of clock branches, the global clock trunk propagating the global clock signal across the fabric and in each region, in the same direction as the data carry chains.

### TECHNICAL FIELD

The present disclosure relates to programmable logic devices (PLDs), such as field-programmable gate arrays (FPGAs), and, in particular for example, to systems and methods for managing clock signals in a programmable logic device.

### BACKGROUND

Programmable logic devices (PLDs) (e.g., field programmable gate arrays (FPGAs), complex programmable logic devices (CPLDs), field programmable systems on a chip (FPSCs), or other types of programmable devices) may be configured with various user designs to implement desired functionality. Typically, the user designs are synthesized and mapped into configurable resources (e.g., programmable logic gates, look-up tables (LUTs), embedded hardware, or other types of resources) and interconnections available in particular PLDs. Physical placement and routing for the synthesized and mapped user designs may then be determined to generate configuration data for the particular PLDs.

The timing of clock and data signals in a PLD is affected by the area of the PLD, processing operations, and the complexity of various PLD components which can lead to mismatches such as delays or timing mismatch between PLD components. Various approaches to eliminate mismatches between clock channels and data channels include layout techniques, providing gate delays, and trimming. However, these approaches often add delay elements to slow processing which further increases the costs and PLD area. In view of the foregoing, there is a need for improved clock techniques for PLDs, which may reduce and/or control mismatch and provide improved skew control.

### SUMMARY

Various techniques are provided to efficiently synchronize clock and data signals in programmable logic devices (PLDs). In some implementations, a method includes configuring a programmable logic device (PLD) having a fabric of programmable logic blocks arranged in a plurality of regions; routing data carry chains in a first direction across the fabric to each of the plurality of regions; placing global clock circuitry at a first edge of the PLD; and routing the global clock to a corresponding first edge of each region via a global clock trunk and a plurality of clock branches, the global clock trunk propagating the global clock signal in across the fabric and each region, in the same direction as the data carry chains.

In some implementations, a programmable logic device (PLD) includes a fabric of programmable logic blocks arranged in a plurality of regions; data carry chain routing configured to propagate in a first direction across the fabric to each of the plurality of regions; global clock circuitry located at a first edge of the PLD; and global clock routing comprising a global clock trunk and a plurality of global clock branches configured to propagate a global clock signal from the first edge of the PLD to a corresponding first edge of each region, wherein the global clock trunk propagates the global clock signal across the fabric and each region, in the same direction as the data carry chains.

### BRIEF DESCRIPTION OF THE DRAWINGS

FIG. 1 illustrates a block diagram of a programmable logic device (PLD) in accordance with an implementation of the disclosure.

FIG. 2 illustrates a block diagram of a logic block for a PLD in accordance with an implementation of the disclosure.

FIG. 3 illustrates an example of clock propagation and data propagation for a PLD, in accordance with an implementation of the disclosure.

FIGS. 4A-B illustrate an example of carry-chain propagation through a PLC compared with clock trunk propagation, in accordance with an implementation of the disclosure.

FIG. 4C illustrates example horizontal fabric routing resources, in accordance with an implementation of the disclosure.

FIG. 5 illustrates and example of the PLD of FIG. 3 with further support for regional clocks, in accordance with an implementation of the disclosure.

FIG. 6 illustrates an example chip plan that may be used to implement the PLD of FIGS. 3 and 5.

FIG. 7 illustrates an example synchronizer circuit, in accordance with an implementation of the disclosure.

FIG. 8A illustrates an example implementation with global clocks propagating from two adjacent corners, in accordance with an implementation of the disclosure.

FIG. 8B illustrates the PLD of FIG. 8A further including pulse circuitry, in accordance with an implementation of the disclosure.

FIG. 8C illustrates an example of duty-cycle restoration, in accordance with an implementation of the disclosure.

FIG. 8D illustrates an example pulse circuit, in accordance with an implementation of the disclosure.

FIG. 9 illustrates example vertical fabric routing resources and clock branches of the implementation of FIG. 8, in accordance with an implementation of the disclosure.

FIG. 10 illustrates an example implementation of the PLD of FIGS. 8A-9 with further support for regional clocks, in accordance with an implementation of the disclosure.

FIG. 11 illustrates an example chip plan that may be used to implement the PLD of FIGS. 8A-9, in accordance with an implementation of the disclosure.

FIG. 12 illustrates a first example of clock distribution within regions, in accordance with an implementation of the disclosure.

FIG. 13 illustrates a second example of clock distribution within regions, in accordance with an implementation of the disclosure.

FIG. 14 illustrates a third example of clock distribution within regions, in accordance with an implementation of the disclosure.

FIG. 15 illustrates an implementation of a chip plan for IOs located on the top and bottom edges of the die, in accordance with an implementation of the disclosure.

FIG. 16 illustrates an example design process for implementing a low noise clock system on a PLD, such as described with reference to FIGS. 1-15, in accordance with an implementation of the disclosure.

### DETAILED DESCRIPTION

The present disclosure is directed to systems and methods for mitigating supply noise and clock jitter during switching activity in the core of an FPGA. As supply voltages are reduced and logic density is increased, control of supply noise and clock jitter becomes more challenging. Further, data propagation delay through long routing resources in the FPGA fabric can limit the maximum clock frequency (FMAX) at which the FPGA can operate and update registers.

It is recognized that having low inductance supply and ground ports in the FPGA package and decoupling capacitors on the board are used to minimize noise. Building multi-layers packages with integrated ground and power planes, along with including chip capacitors in the package adds expense, but may be required to meet certain implementation requirements. Integrating more decoupling caps on the die itself can be effective, however, it increases die-size and adds to the cost. It is further recognized that propagation delay may be reduced by using large drivers made up of low threshold voltage transistors and using wider conductors to reduce resistance. This approach lowers the resistor-capacitor time constant, but may increase leakage and capacitance resulting in higher power consumption.

In accordance with implementations of the present disclosure, supply noise and the resulting clock jitter are mitigated by reducing and/or avoiding simultaneous switching in the FPGA core. Switching activity in the FPGA die is timed by clocks and simultaneous switching results in high amplitude supply noise. In various implementations, simultaneous switching may be avoided by progressively increasing clock delay across the chip. In some implementations, the global clocks are driven from one side of the die thereby avoiding the use of an H-tree clock structure in at least one dimension and mitigating supply noise and clock jitter.

In various implementations, configuring a progressively increasing clock delay across the FPGA die can further result in higher performance. For example, the direction of clock propagation can be configured to be the same as the direction of data propagation (such as carry-chain propagation). In that same direction, effective routing delays may also be reduced. Thus, with appropriate logic placement, critical paths will have less effective delay than with ‘flat’ timing, enabling higher frequency operation in some embodiments.

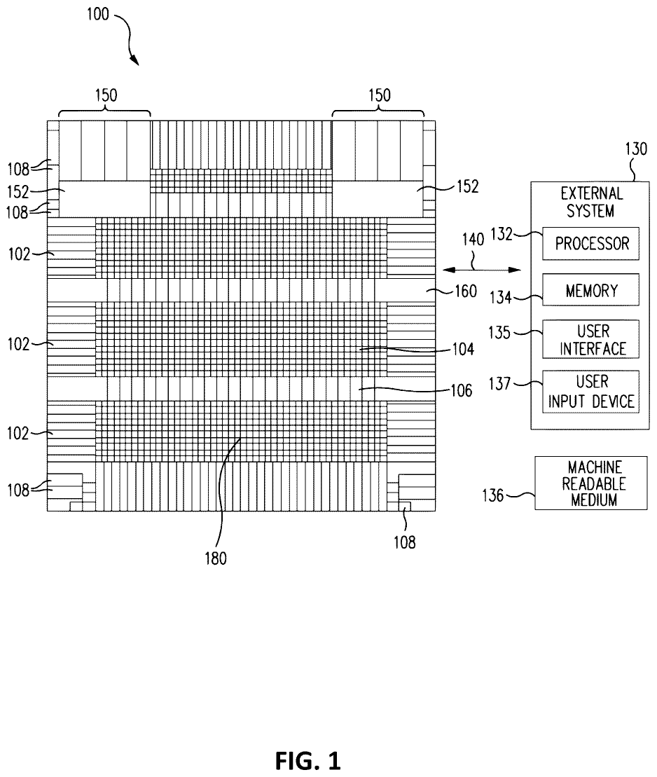

Referring now to the drawings, FIG. 1 illustrates a block diagram of a programmable logic device (PLD 100) in accordance with an implementation of the disclosure. PLD 100 (e.g., a field programmable gate array (FPGA)), a complex programmable logic device (CPLD), a field programmable system on a chip (FPSC), or other type of programmable device) generally includes input/output (I/O) blocks 102 and logic blocks 104 (e.g., also referred to as programmable logic blocks (PLBs), programmable functional units (PFUs), or programmable logic cells (PLCs)).

I/O blocks 102 provide I/O functionality (e.g., to support one or more I/O and/or memory interface standards) for PLD 100, while programmable logic blocks 104 provide logic functionality (e.g., LUT-based logic or logic gate array-based logic) for PLD 100. Additional I/O functionality may be provided by serializer/deserializer (SERDES) blocks 150 and physical coding sublayer (PCS) blocks 152. PLD 100 may also include hard intellectual property core (IP) blocks 160 to provide additional functionality (e.g., substantially predetermined functionality provided in hardware which may be configured with less programming than logic blocks 104).

PLD 100 may also include blocks of memory 106 (e.g., blocks of EEPROM, block SRAM, and/or flash memory), clock-related circuitry 108 (e.g., clock sources, PLL circuits, and/or DLL circuits), and/or various routing resources 180 (e.g., interconnect and appropriate switching logic to provide paths for routing signals throughout PLD 100, such as for clock signals, data signals, or others) as appropriate. In general, the various elements of PLD 100 may be used to perform their intended functions for desired applications, as would be understood by one skilled in the art.

For example, certain I/O blocks 102 may be used for programming memory 106 or transferring information (e.g., various types of user data and/or control signals) to/from PLD 100. Other I/O blocks 102 include a first programming port (which may represent a central processing unit (CPU) port, a peripheral data port, an SPI interface, and/or a sysCONFIG programming port) and/or a second programming port such as a joint test action group (JTAG) port (e.g., by employing standards such as Institute of Electrical and Electronics Engineers (IEEE) 1149.1 or 1532 standards). In various implementations, I/O blocks 102 may be included to receive configuration data and commands (e.g., over one or more connections 140) to configure PLD 100 for its intended use and to support serial or parallel device configuration and information transfer with SERDES blocks 150, PCS blocks 152, hard IP blocks 160, and/or logic blocks 104 as appropriate.

It should be understood that the number and placement of the various elements are not limiting and may depend upon the desired application. For example, various elements may not be required for a desired application or design specification (e.g., for the type of programmable device selected).

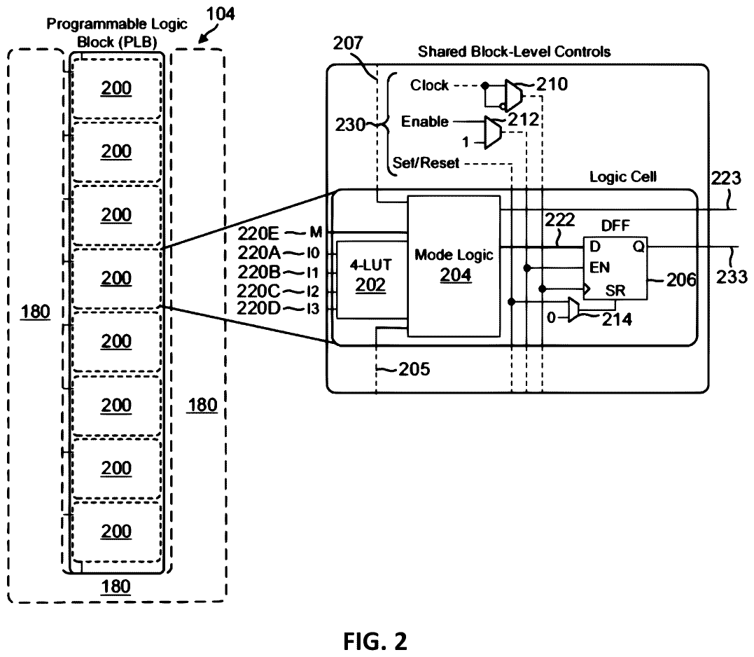

Furthermore, it should be understood that the elements are illustrated in block form for clarity and that various elements would typically be distributed throughout PLD 100, such as in and between logic blocks 104, hard IP blocks 160, and routing resources (e.g., routing resources 180 of FIG. 2) to perform their conventional functions (e.g., storing configuration data that configures PLD 100 or providing interconnect structure within PLD 100). It should also be understood that the various implementations disclosed herein are not limited to programmable logic devices, such as PLD 100, and may be applied to various other types of programmable devices, as would be understood by one skilled in the art.

An external system 130 may be used to create a desired user configuration or design of PLD 100 and generate corresponding configuration data to program (e.g., configure) PLD 100. For example, system 130 may provide such configuration data to one or more I/O blocks 102, SERDES blocks 150, and/or other portions of PLD 100. As a result, programmable logic blocks 104, various routing resources, and any other appropriate components of PLD 100 may be configured to operate in accordance with user-specified applications.

In the illustrated implementation, system 130 is implemented as a computer system. In this regard, system 130 includes, for example, one or more processors 132 which may be configured to execute instructions, such as software instructions, provided in one or more memories 134 and/or stored in non-transitory form in one or more non-transitory machine-readable mediums 136 (e.g., which may be internal or external to system 130). For example, in some implementations, system 130 may run PLD configuration software, such as Lattice Diamond® System Planner software or Radiant® available from Lattice Semiconductor Corporation to permit a user to create a desired configuration and generate corresponding configuration data to program PLD 100.

System 130 also includes, for example, a user interface 135 (e.g., a screen or display) to display information to a user, and one or more user input devices 137 (e.g., a keyboard, mouse, trackball, touchscreen, and/or other device) to receive user commands or design entry to prepare a desired configuration of PLD 100.

FIG. 2 illustrates a block diagram of a logic block 104 of PLD 100 in accordance with an implementation of the disclosure. As discussed, PLD 100 includes a plurality of logic blocks 104 including various components to provide logic and arithmetic functionality.

In the example implementation shown in FIG. 2, logic block 104 includes a plurality of logic cells 200, which may be interconnected internally within logic block 104 and/or externally using routing resources 180. For example, each logic cell 200 may include various components such as: a lookup table (LUT) 202, a mode logic circuit 204, a register 206 (e.g., a flip-flop or latch), and various programmable multiplexers (e.g., programmable multiplexers 210, 212 and 214 used for control signals in the figure). Other multiplexers may be in the mode logic for dynamically selecting between one 4-LUT output and the output of a different 4-LUT as controlled by the signal M. Hence, selecting desired signal paths for logic cell 200 and/or between logic cells 200. In this example, LUT 202 accepts four inputs 220A-220D, which makes it a four-input LUT (which may be abbreviated as “4-LUT” or “LUT4”) that can be programmed by configuration data for PLD 100 to implement any appropriate logic operation having four inputs or less. Mode Logic 204 may include various logic elements and/or additional inputs, such as input 220E, to support the functionality of the various modes, as described herein. LUT 202 in other examples may be of any other suitable size having any other suitable number of inputs for a particular implementation of a PLD. In some implementations, different size LUTs may be provided for different logic blocks 104 and/or different logic cells 200.

An output signal 222 from LUT 202 and/or mode logic 204 may in some implementations be passed through register 206 to provide an output signal 233 of logic cell 200. In various implementations, an output signal 223 from LUT 202 and/or mode logic 204 may be passed to output 223 directly, as shown. Depending on the configuration of multiplexers 210-214 and/or mode logic 204, output signal 222 may be temporarily stored (e.g., latched) in latch (or FF) 206 according to control signals 230. In some implementations, configuration data for PLD 100 may configure output 223 and/or 233 of logic cell 200 to be provided as one or more inputs of another logic cell 200 (e.g., in another logic block or the same logic block) in a staged or cascaded arrangement (e.g., comprising multiple levels) to configure logic operations that cannot be implemented in a single logic cell 200 (e.g., logic operations that have too many inputs to be implemented by a single LUT 202). Moreover, logic cells 200 may be implemented with multiple outputs and/or interconnections to facilitate selectable modes of operation.

Mode logic circuit 204 may be utilized for some configurations of PLD 100 to efficiently implement arithmetic operations such as adders, subtractors, comparators, counters, or other operations, to efficiently form some extended logic operations (e.g., higher order LUTs, working on multiple bit data), to efficiently implement a relatively small RAM, and/or to allow for selection between logic, arithmetic, extended logic, and/or other selectable modes of operation. In this regard, mode logic circuits 204, across multiple logic cells 202, may be chained together to pass carry-in signals 205 and carry-out signals 207, and/or other signals (e.g., output signals 222) between adjacent logic cells 202, as described herein. In the example of FIG. 2, carry-in signal 205 may be passed directly to mode logic circuit 204, for example, or may be passed to mode logic circuit 204 by configuring one or more programmable multiplexers, as described herein. In some implementations, mode logic circuits 204 may be chained across multiple logic blocks 104.

Logic cell 200 illustrated in FIG. 2 is merely an example, and logic cells 200 according to different implementations may include different combinations and arrangements of PLD components. Also, although FIG. 2 illustrates logic block 104 having eight logic cells 200, logic block 104 according to other implementations may include fewer logic cells 200 or more logic cells 200. Each of the logic cells 200 of logic block 104 may be used to implement a portion of a user design implemented by PLD 100. In this regard, PLD 100 may include many logic blocks 104, each of which may include logic cells 200 and/or other components which are used to collectively implement the user design.

Portions of a user design may be adjusted to occupy fewer logic cells 200, fewer logic blocks 104, and/or with less burden on routing resources 180 when PLD 100 is configured to implement the user design. Such adjustments according to various implementations may identify certain logic, arithmetic, and/or extended logic operations, to be implemented in an arrangement occupying multiple implementations of logic cells 200 and/or logic blocks 104. An optimization process may route various signal connections associated with the arithmetic/logic operations such that a logic, ripple arithmetic, or extended logic operation may be implemented into one or more logic cells 200 and/or logic blocks 104 to be associated with the preceding arithmetic/logic operations. The synchronization of clock signals, data, and other signals in a PLD is an important aspect of system design and performance. Many data signals will arrive at a circuit component at different times based on processing delays, signal path length, and other design aspects and system constraints. These variations can limit the performance of the design.

As previous discussed with respect to FIGS. 1-2, a PLD is designed to perform a desired function using various interconnected elements that may include blocks of memory (e.g., embedded block memory (EBR)), a clock distribution network (e.g., a clock tree), special function blocks (e.g., digital signal processing (DSP) blocks), routing resources, logic blocks (e.g., programmable logic cells (PLCs), and other elements.

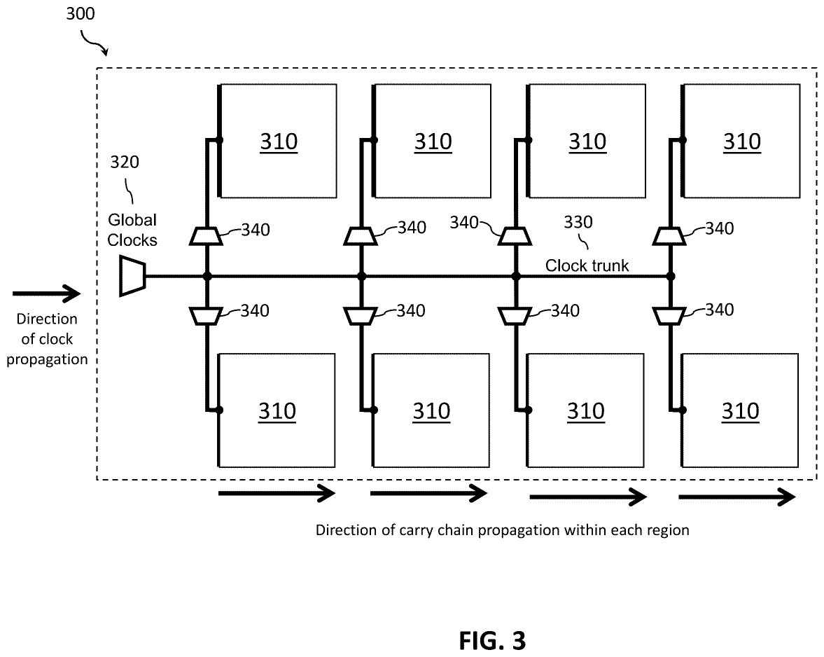

FIG. 3 illustrates an example implementation of clock propagation and data propagation for an example PLD, such as PLD 100 described with reference to FIGS. 1-2. As illustrated, a PLD 300 fabric is divided into a plurality of regions 310, which may include various elements/blocks having different clock and data signal delays. Although FIG. 3 illustrates a PLD 300 including eight regions 310, according to other implementations PLD 300 may include fewer regions 310 or more regions 310, which may be arranged in fewer or more rows and/or columns.

The PLD 300 further includes global clocks 320 which are propagated from an edge of the PLD 300 across the PLD 320 via a clock trunk 330. The global clock signals are provided vertically to an edge of each region 310 and may be selected via a multiplexer 340. The global clocks 320 and the clock trunk 330 may include one or more signals (e.g., 8 clocks, 16 clocks, 64 clocks, etc.), and the vertical lines, via each of the multiplexers 340, may propagate a subset of the global clocks 320 (e.g., 64 global clock signals propagated horizontally and a subset of 16 clocks selected via the multiplexer 340 going to each region).

In some PLD implementations, clock signals may be routed from a central clock multiplexer through an H-tree topology to equalize clock delay to each region 310. This approach provides some advantages, such as low clock skew between regions. However, this approach results in simultaneous switching of logic that is controlled by the clock across the die, generating large current spikes which increases supply noise and resultant jitter. Another disadvantage is that the H-tree topology consumes more power than the approaches described herein.

In the approach illustrated in FIG. 3, both clock propagation and data propagation (e.g., carry chains) are propagated from the same side of the PLD 300 die (e.g., from left to right in the illustrated embodiment) and one side of each region 310. For example, if the carry chains propagate from bottom to top, the clock would also propagate from bottom to top. Logic that is controlled by the clock signal will thus switch when the clock transitions local to that logic. Since carry chain delay can limit performance, the choice to run the clock lines in the same direction as the carry chains has the benefit that clock propagation delay is effectively subtracted from carry delay since the internal timing is relative to the clock. In this approach, clock delay/timing is uniform in the vertical direction, but increases from left to right.

The implementation of FIG. 3 provides numerous advantages over an H-tree design, which is used distribute global clocks from a central location on the PLD to a central location of each region. The H-tree design provides uniform timing across the chip, but the simultaneously switching of synchronized circuitry (e.g., flip-flops, LUTs, PLCs, etc.) across a PLD may create a high current surge across the PLD, can create large fluctuations in the internal supply voltage which can, for example, affect jitter and cause disruption to the internal supply voltage.

The implementation of FIG. 3 spreads out the clock arrival times across the PLD. In this approach, the global clocks 320 are propagated from one side (the left side in the illustrated implementation) to the middle of the regions vertically. This approach adds delay across the chip (from left to right in the illustrated implementation) resulting in cascaded switching across the chip, which avoids the problems discussed above with simultaneous switching. As the clock switches, the region 310 on the left will switch first, followed sequentially by the regions to the right, until the rightmost region receives the global clock 320 signal. This approach avoids the instantaneous current draw from all regions associated with the simultaneous switching on the chip. Thus, although the same net current is being switched, because it isn't being switched at the same time it is much quieter in terms of supply noise.

Another advantage of this approach relates to clock timing. In a conventional approach, when the clock arrives at the same time in different regions, a data source and destination register on the chip may receive the clock signal at the same time. Thus, the system is limited by the propagation delay between the data source and destination. Data propagation is relatively slow across the chip. Because the clock arrives early at the destination, we may need to slow down the clock frequency so that at the next clock cycle, the data is received. Thus, the frequency is limited to allow the data to propagate to the next register. The implementation of FIG. 3, however, propagates the clock in the same direction as the data. When the clock is propagating in the same direction, we can subtract the delay of the clock from the data propagation delay and now we can run at a higher frequency. From the perspective of the sampling register it appears that the data propagated more quickly because it arrives with less delay after the clock arrives.

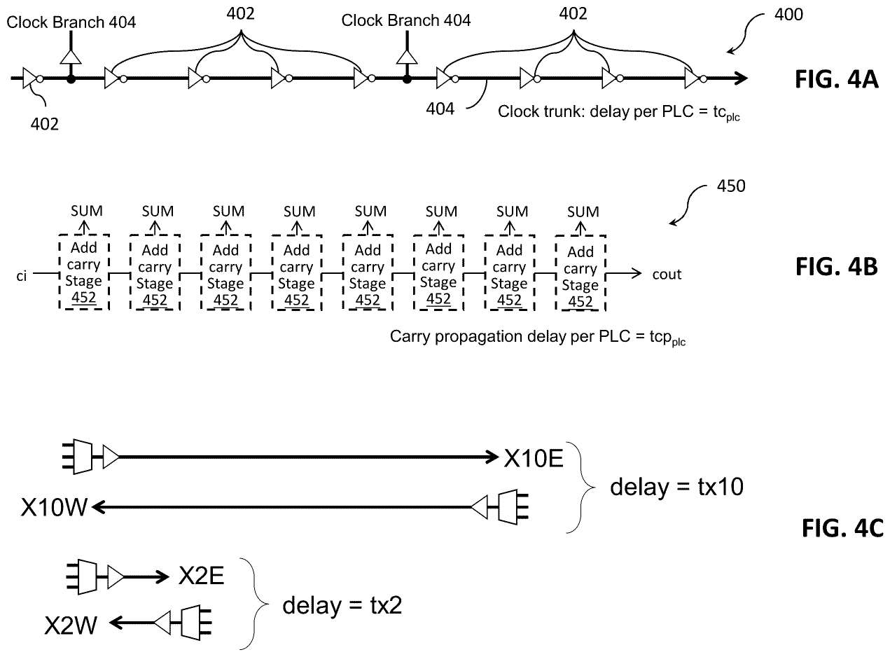

FIGS. 4A-B illustrate an example of carry-chain propagation through a PLC compared with clock trunk propagation. FIG. 4A illustrates an example physical design for clock trunk propagation 400 across a clock trunk 404, including optional inverters 402 and clock branches 404 providing clock signals to each region, with clock delay increasing from one side of the PLD to the other side (e.g., left to right in the illustrated implementation). The clock delay for each PLC is represented by tc_{plc}.

Referring to FIG. 4B, the timing of carry logic 450 is relative to the global clocks which may be treated as having 0 delay, even though physical delay progressively increases from left to right across each carry stage 452. The carry logic 450 typically propagates more slowly than the clock, allowing use of slower clock in the illustrated implementation without sacrificing performance. The carry propagation delay for each PLC is represented by tcp_{plc}. Thus, the effective carry propagation delay is tcpe_{plc}=tcp_{plc}−tc_{plc}. Thus, as clock propagation slows down, the effective carry propagation speeds up.

In various implementations, clock delay is subtracted from the delay of routing resources that propagate in the same direction as clock, while adding to the effective delay of routing resources running in the opposite direction. Because of this, for speed designs the datapath propagates downstream in the direction of the clock. As long as the clock propagation is faster than routing delay, a slower clock will actually enable higher performance. As discussed, all timing is relative to the global clocks which are treated as having 0 delay, even though physical delay progressively increases.

FIG. 4C illustrates example fabric routing resources, according to implementations of the present disclosure. In various implementations, the timing is relative to the global clocks, which are treated as having zero delay, even though the physical delay progressively increases, and additional propagation delay is added due to the physical routing resources. Global Building Block timing model parameters (GBBs) of routing resources are compensated by clock delay and are handled in the sense that east heading segments have less effective delay than west heading ones. Clock delay is limited to where effective routing delays are always >0 (for hold-time). For example, for X10 wire segments the transmission delay heading east (e.g., left to right in the illustrated implementation) is equal to tx10−10*tc_{plc}>0; the transmission delay heading west (e.g., right to left in the illustrated implementation) is equal to tx10+10*tc_{plc}; the transmission delay heading north (e.g., heading up in the illustrated implementation) is equal to tx10; and the transmission delay heading south (e.g., down in the illustrated implementation) is equal to tx10. As another example, for X2 wire segments the transmission delay heading east is equal to tx10−2*tc_{plc}>0; the transmission delay heading west is equal to tx10+2*tc_{plc}; the transmission delay heading north is equal to tx2; and the transmission delay heading south is equal to tx2.

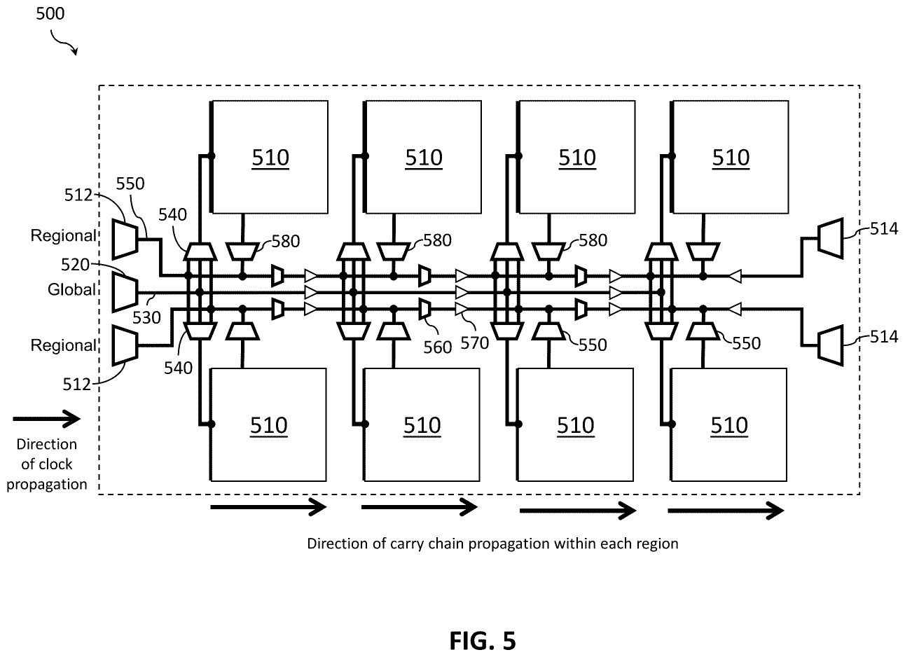

FIG. 5 illustrates an example implementation supporting regional clocks. In the illustrated implementation, a PLD 500 fabric is divided into a plurality of regions 510, which may include various elements/blocks having different clock and data signal delays. Although FIG. 5 illustrates a PLD 500 including eight regions 510, according to other implementations PLD 500 may include fewer regions 510 or more regions 510, which may be arranged in fewer or more rows and/or columns.

In the approach illustrated in FIG. 5, both global clock propagation and data propagation are propagated from the same side of the PLD 500 die (e.g., from left to right in the illustrated implementation) and one side of each region 510. Regional clocks 512 may also be implemented in the PLD 500, and may propagate in the same direction as the global clock. In some implementations, regional clocks 514 may also be provided to propagate to certain regions from another direction. As shown, regional clocks 514 only connect to the right most regions when the global clocks propagate from the left side of the PLD. Each regional clock trunk 550, may include one or more multiplexers 560 and buffers 570 for selecting and synchronizing clock signals, and vertical branches/multiplexers 580 providing regional clock signals to each region 510.

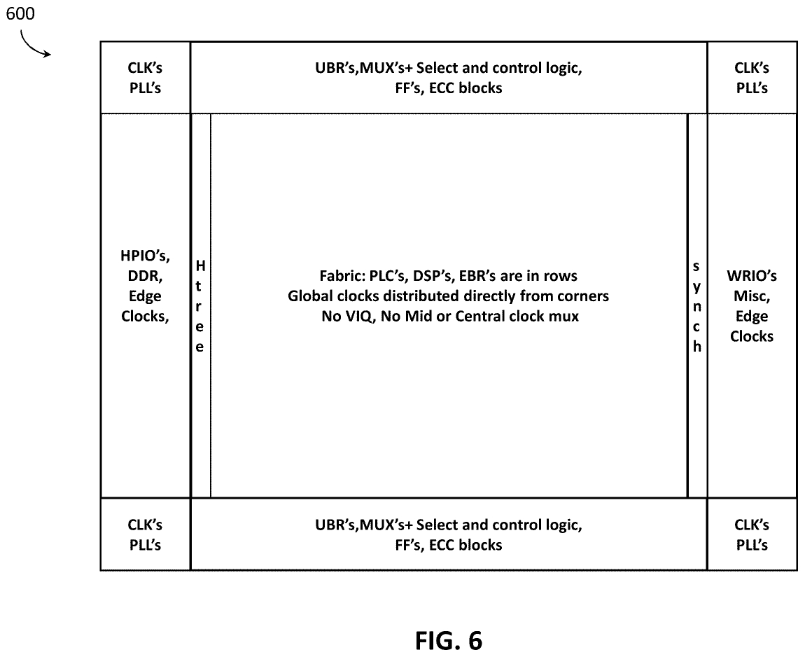

FIG. 6 shows an example chip plan 600 that may be used to implement the PLD described above with respect to FIGS. 1-5. For clocks and carry logic running horizontally, the IO's are on the left and right sides of the die so that timing would be uniform within each side. Other fabric blocks such as DSP's and EBR's may be organized in horizontal rows. Memory access and DSP operations would thus also be progressively delayed (from left to right), as they are also timed by the clock(s), so that data-path propagation from left to right would result in data and global clocks arriving at the right side IO's with little relative delay but significant absolute delays.

In the illustrated implementation, PLLs on left side support edge-clocks and global clocks, which propagate from the left side to the right side. Carry chains also propagate from the left side to the right side. IOs may have a uniform timing relationship with the global clocks. A vertical H-tree for the global clock may be provided on the left edge. By taking User Block RAM (UBRs) out of the fabric and putting them on the top and bottom edges, the fabric region is more compact which may be better for power and performance of the fabric using PLCs, EBRs, and DSPs. It may also be better for supporting large flexible multi-port memories as there is room for programmable muxes and bus routing for this purpose, as well as SEC blocks to be shared among UBR blocks. UBRs can be used individually or aggregated (using dedicated resources) to form large multiport memories. A sync-layer may be provided for adapting the timing of core data to the right side and right-side data to the global clocks. PLLs and dedicated clock inputs, DCSs, DCCs, Clk dividers and related circuitry may be provided in the corners (only in the corners in some implementations); on the right side providing support for edge clocks and local regional clocks (and sync), and on the left side providing support for edge clocks, local regional clocks and global clocks.

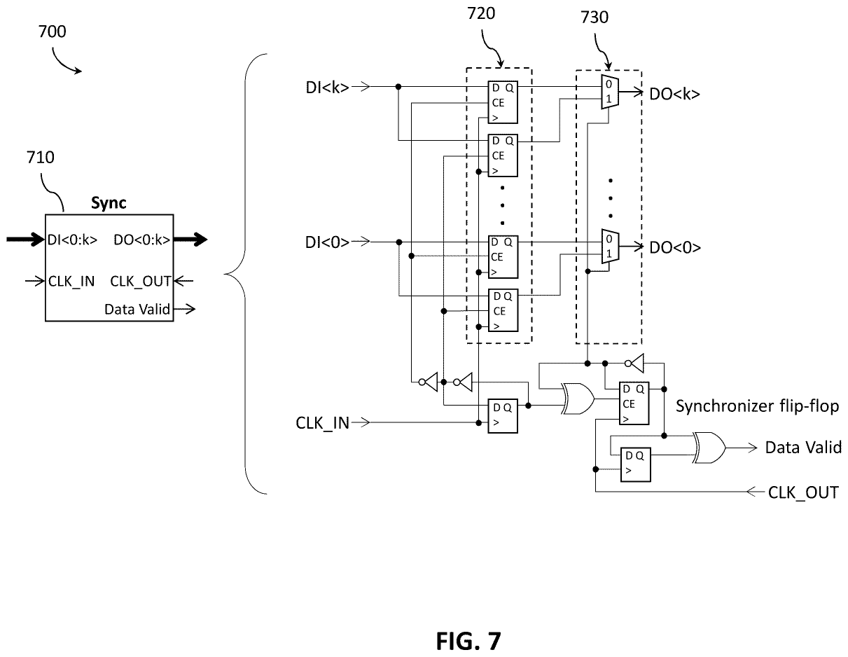

FIG. 7 illustrates an example synchronizer circuit 700 that may be used to synchronize data from a global clock domain to a local clock domain, which may be implemented using, for example, D flip flop circuitry. The two lower right flip-flops that provide the Data Value signal and the select input to the 2:1 muxes are synchronizers. The sync-layer adapts timing of core data to the right side clock and right-side data to global clocks. In some implementations, the data is sampled in flip-flops 720 and output via muxes 730.

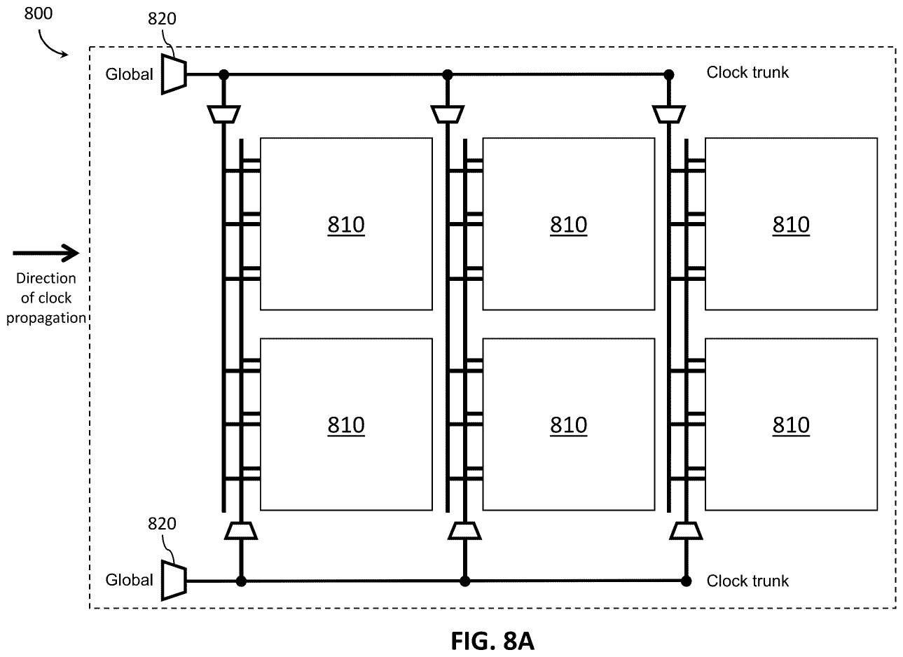

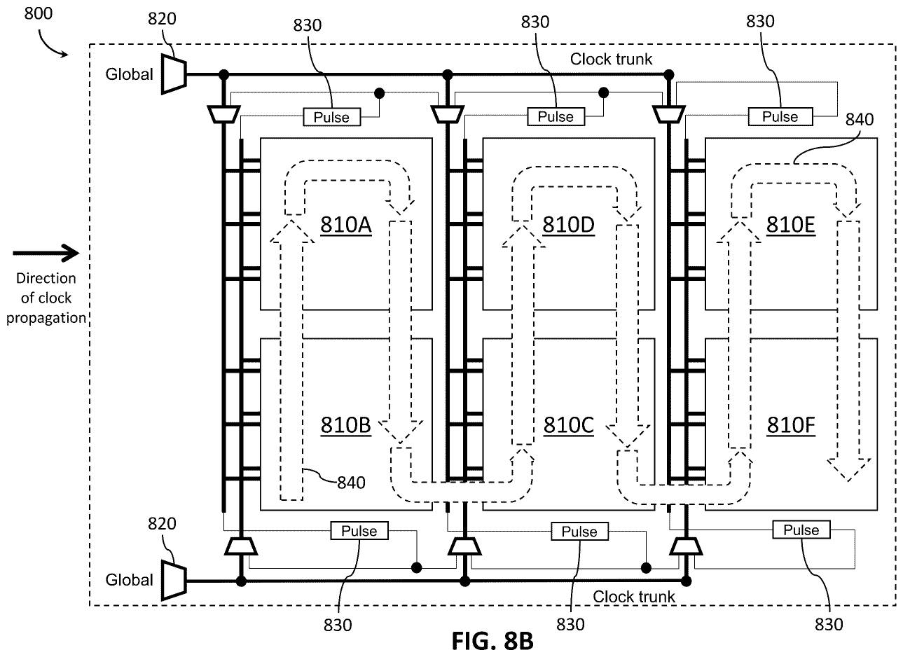

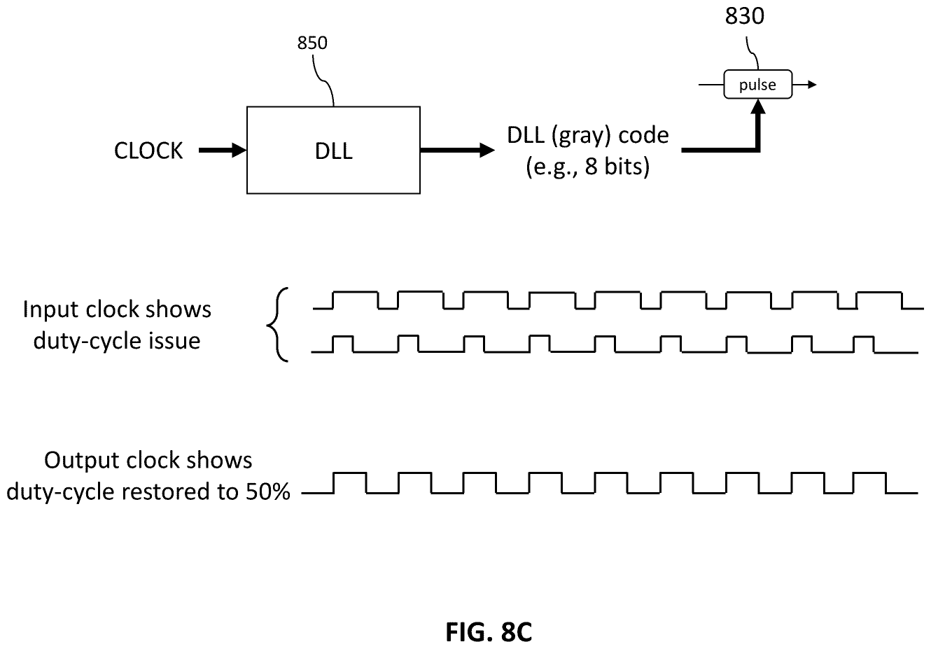

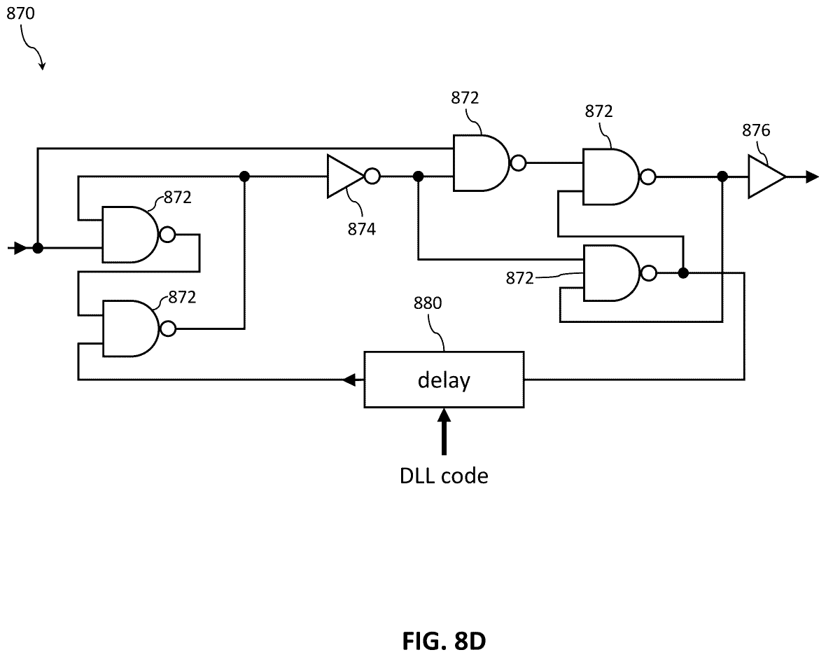

FIG. 8A illustrates an example implementation where the global clocks 820 propagate from 2 adjacent corners of the PLD 800, in this case the upper left and lower left. In this implementation, an HIQ is not required and the DCS, clock dividers, and other circuitry is provided in the lower left and upper left corners. In this implementation, the carry logic propagates from left to right across regions 810, resulting in a high speed data-path from left to right and bottom to top and/or top to bottom.

Referring to FIG. 8B, in some embodiments, a clock branch (vertical direction) originating in one corner may be selected to drive another clock branch in the opposite (vertical) direction. This can be used to facilitate meandering high-speed data-paths (e.g., data path 840 in the illustrated implementation) through the fabric by using clocks that propagate in the same direction as the data path 840. To mitigate and/or avoid duty-cycle degradation, duty-cycle restoration may be provided using optional pulse circuitry 830 to connect a north clock trunk with a south clock trunk allowing the clock signal propagation to follow the data path 840. The pulse circuitry 830 may be a fixed delay or alternatively may include, for example, a digitally controlled (e.g., gray code) delay that is tuned using a shared DLL.

FIG. 8C illustrates an example of duty-cycle restoration, in accordance with an implementation of the disclosure. In the illustrated implementation, the pulse circuit 830 receives a digitally controlled (gray code) delay that is tuned using a DLL 850, which may be shared. The delay may be calibrated, for example, to half the period of the clock. In this case, an output clock may have a duty-cycle restored to 50%, with the rising edge synchronous to the input clock and the falling edge adjusted to provide a 50% duty cycle.

FIG. 8D illustrates an example pulse circuit 870, in accordance with an implementation of the disclosure. In the illustrated implementation, the pulse circuit 870 includes a plurality of circuit elements, such as NAND gates 872, INVERTER 874, buffer 876, and delay circuitry 880, which is configurable using a DLL code such as previously discussed. In some embodiments, a pulse circuit may be implemented with other circuit elements in other configurations consistent with the present disclosure. As illustrated, the pulse circuit 870 receives a clock signal and generates an output voltage triggered on the rising edge of the input clock signal.

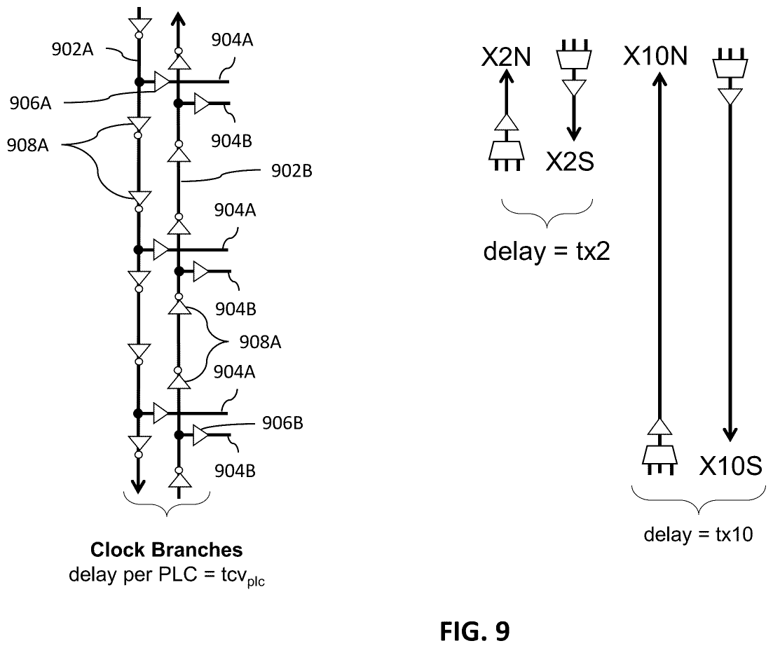

FIG. 9 illustrates example GBBs for routing resources of the implementation of FIG. 8. Horizontal routing resources may be treated the same as in FIGS. 3-4C (clock delay subtracted from right directed resources and added to left directed resources). Vertical resources will be assigned a GBB which depends on the direction of the clock involved. As illustrated, a first global clock trunk 902A propagates from the upper left and is directed south/downward, and has clock branches 904A to each region. A second global clock trunk 902B propagates from the lower left and is directed north/upward, and has clock branches 904B to each region. When the involved clock propagates from the lower-left, a north directed routing resource will have reduced delay, whereas the same routing resource will have increased delay if the involved clock propagates from the upper left corner. Each clock path may further include one or more buffers 906A or inverter pairs 908A as previously discussed.

In the illustrated implementation, the timing may be relative to global clocks which are treated as having 0 delay, even though physical delay progressively increases. GBBs of routing resources compensate for clock delay and are handed. There are two sets of GBBs for vertical routing resources and one set for horizontal routing resources. Clock delay is limited so that effective routing delays are always greater than zero (for hold-time). Depending on the physical design, in addition to increasing delay from left to right, a particular clock may have delay increases from top to bottom or bottom to top.

In an example implementation, the fabric routing resources for X10 wire segments of a north directed clock, may have transmission delays heading east (e.g., left to right in the illustrated implementation) equal to tx10−10*tc_{plc}>0; transmission delays heading west (e.g., right to left in the illustrated implementation) may be equal to tx10+10*tc_{plc}; transmission delays heading north (e.g., heading up in the illustrated implementation) is equal to tx10−10*tcv_{plc}>0; and transmission delays heading south (e.g., down in the illustrated implementation) may be equal to tx10+10*tcv_{plc}. For fabric routing resources for X10 wire segments of a south directed clock, transmission delays heading east may be equal to tx10−10*tc_{plc}>0; transmission delays heading west may be equal to tx10+10*tc_{plc}; transmission delays heading north may be equal to tx10+10*tcv_{plc}; and transmission delays heading south may be equal to tx10−10*tcv_{plc}>0

As another example, the fabric routing resources for X2 wire segments of a north directed clock, may have transmission delays heading east equal to tx10−2*tc_{plc}>0; transmission delays heading west may be equal to tx10+2*tc_{plc}; transmission delays heading north may be equal to tx10−2*tcv_{plc}>0; and transmission delays heading south may be equal to tx2+2*tcv_{plc}. For fabric routing resources for X2 wire segments of a south directed clock, transmission delays heading east may be equal to tx10−2*tc_{plc}>0; transmission delays heading west may be equal to tx10+2*tc_{plc}; transmission delays heading north may be equal to tx2+2*tcv_{plc}; and transmission delays heading south may be equal to tx2−2*tcv_{plc}>0.

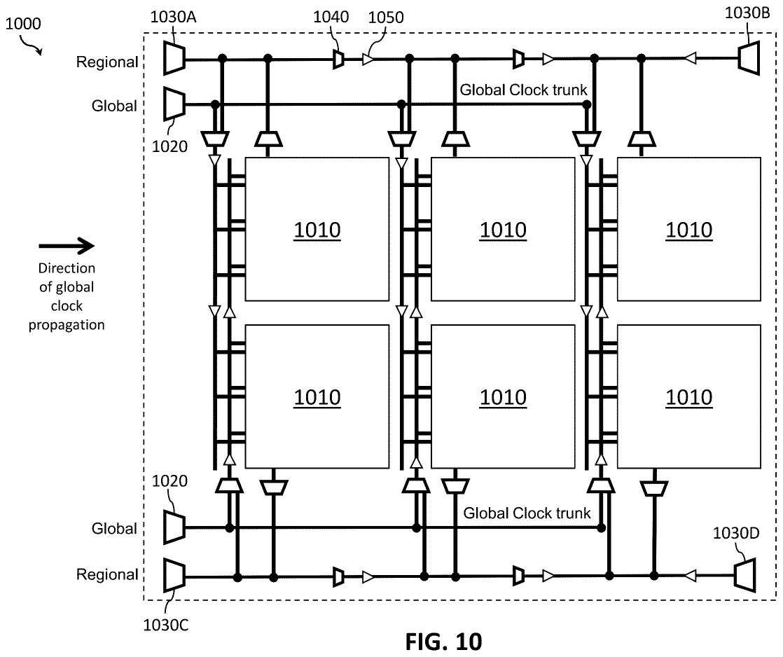

FIG. 10 illustrates an example implementation of FIGS. 8-9 adapted for use with regional clocks. Regional clocks 1030A-D, which are integrated with the global clock 1020, can originate from IO's, PLL's, E-CLOCKS, Serdes, CIB inputs, or other circuitry. Regional clock 1030A and regional clock 130C propagation is left to right in the illustrated implementation, both within a region 1010 and from region to region. Consequently, a regional clock 1030B and/or regional clock 1030D that originates in a right-most region only connects to the right-most region(s) 1010, and this may include IO inputs on the right side. Each regional clock trunk may include one or more multiplexers 1040 and/or buffers 1050 as previously discussed. It will be appreciated that the implementation of FIG. 10 may be implemented with more or less numbers of regional clocks, regions, and other components of the illustrated implementation.

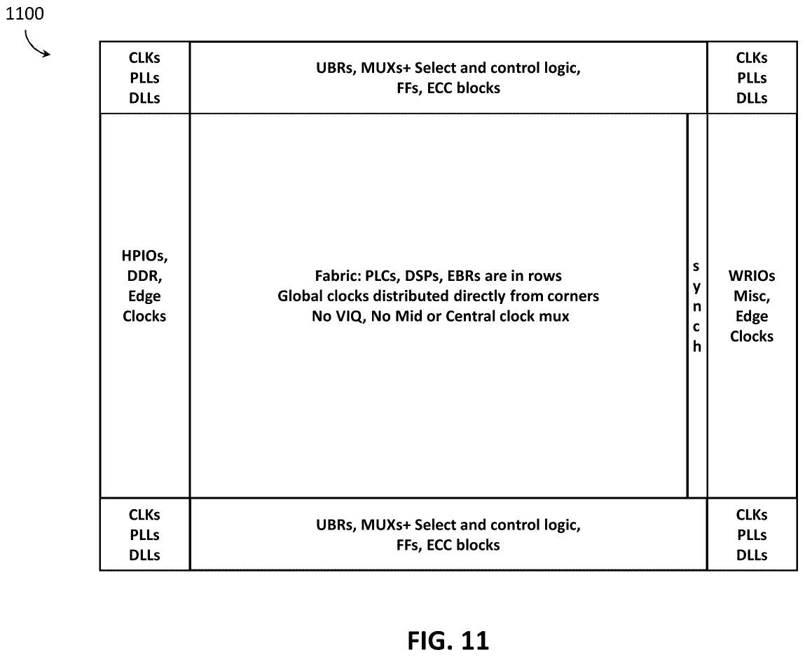

FIG. 11 shows a chip plan appropriate for the implementations illustrated in FIGS. 8-10. In this implementation, the PLLs in the upper left (UL) corner support edge-clocks and global clocks that propagate from the UL corner, and the carry chains are configured to propagate from left to right. The chip layout supports regional clocks originating from within a region, while region-to-region clock propagation is left to right. The PLL's from the LL corner support edge-clocks and global clocks that propagate from the LL corner. By taking UBR's out of the fabric and putting them on the top and bottom edges, the fabric region is more compact which provides advantages for power and performance of the fabric using PLC's, EBR's, DSP's. Further advantages include support for large flexible multi-port memories as there is room for programmable muxes and bus routing for this purpose, as well as SEC blocks to be shared among UBR blocks.

In some implementations, the PLL's and dedicated clock inputs, DCS's, DCC's, Clk dividers, and related circuitry may be located only in the corners. On the right side they support edge clocks (and sync) and regional clocks for the rightmost regions, and on left side they also support global clocks. A sync-layer on the right is for adapting timing of core data to the right side and right-side data to global clocks. UBR's (on the top and bottom) can be used individually or aggregated (using dedicated resources) to form large multiport memories. Global clocks that are driven from LL and LR corners have equal delay in middle rows of the fabric, which enables data transfer there between north and south directed common clock domains. The corner PLLs and DLLs can be used to offset rows where clock domain transfers can occur.

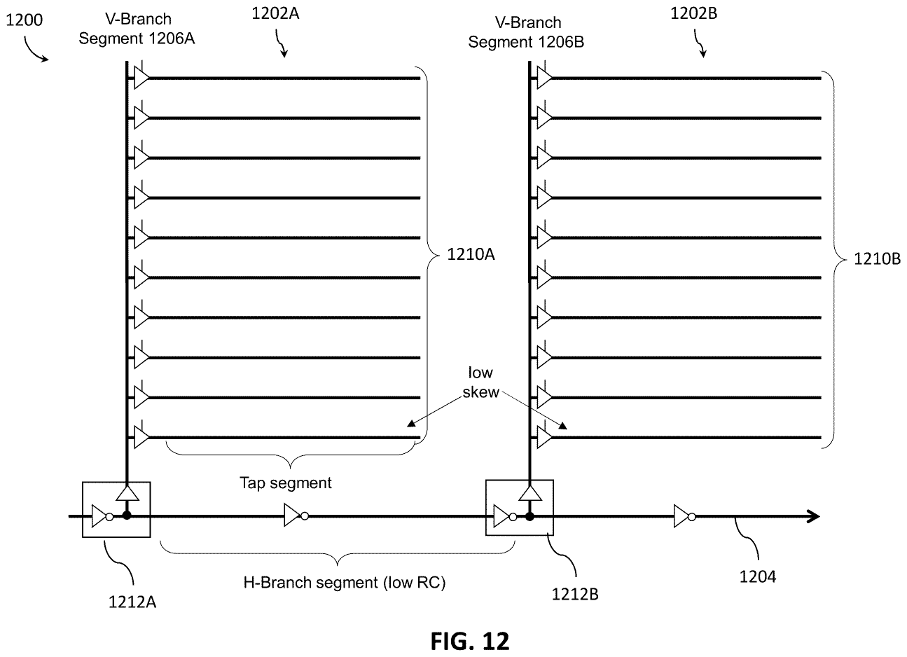

FIG. 12 illustrates an implementation of clock distribution 1200 within regions, such as regions 1202A-B. In this implementation, a global clock trunk 1204 is arranged horizontally and the global clocks propagate from left to right. Region 1202A is connected to the global clocks via a vertical branch segment 1206A, which includes a plurality of tap segments 1210A providing clock signals to the region 1202A. Similarly, region 1202B is connected to the global clocks via a vertical branch segment 1206B, which includes a plurality of tap segments 1210B providing clock signals to the region 1202B. Circuitry 1212A and 1212B provides buffers, inverters or other delay elements to tune the clock timing to reduce skew between regions (e.g., regions 1202A and 1202B). In the illustrated implementation, tap segment delay is RC dominated and the H-branch segment delay is inverter dominated.

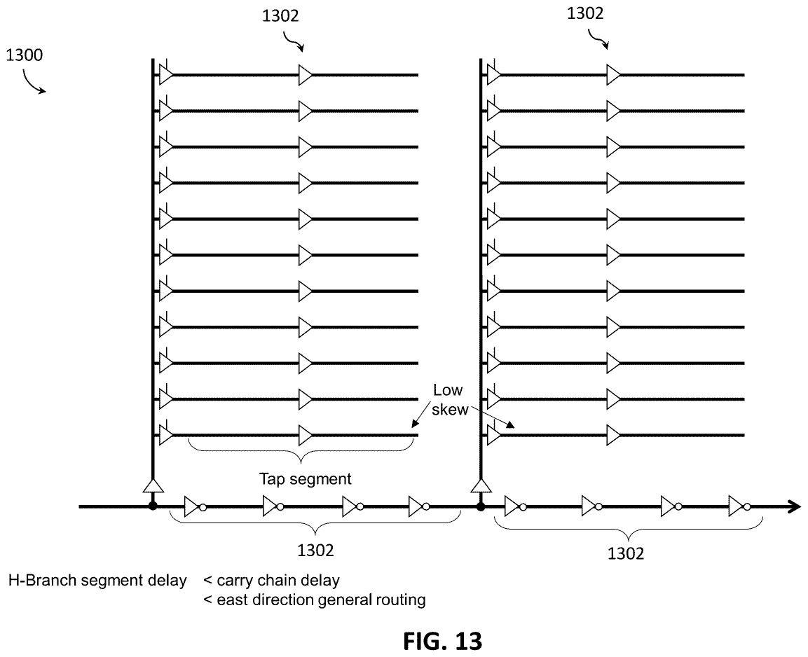

FIG. 13 shows an implementation where clock distribution is slowed down to improve relative timing in a preferred direction (left to right). In this implementation, H-Branch segment delay is less than carry chain delay and less than east direction (e.g., left to right) general routing, and clock delay is deliberately increased via additional delay elements (e.g., buffers, inverters, or other delay elements) to improve performance in one direction.

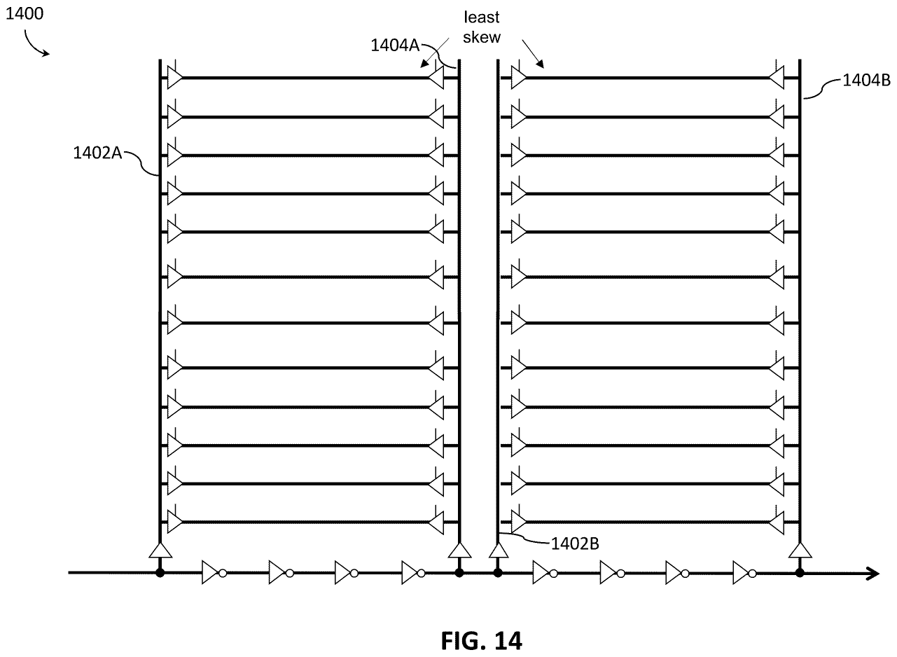

FIG. 14 is another implementation enabling clock regions with a controlled timing gradient with minimum local skew between regions. The illustrated embodiment provides a clock distribution implementation 1400 that improves performance in one direction. Improved skew results are achieved when clocks are driven from both edges of regions providing lower skew between regions. For example, in the illustrated embodiments vertical branches 1402A-B propagate the global clock signals to the left side of each region, and additional vertical branches 1404A-B propagate the global clock signals to the right side of each region. However, in this approach the clock tap related logic is doubled per region, which is generally acceptable for practical implementation because the implementation supports wider regions. In some implementations, contention is avoided by designing RC of tap segment commensurate with branch segment delay.

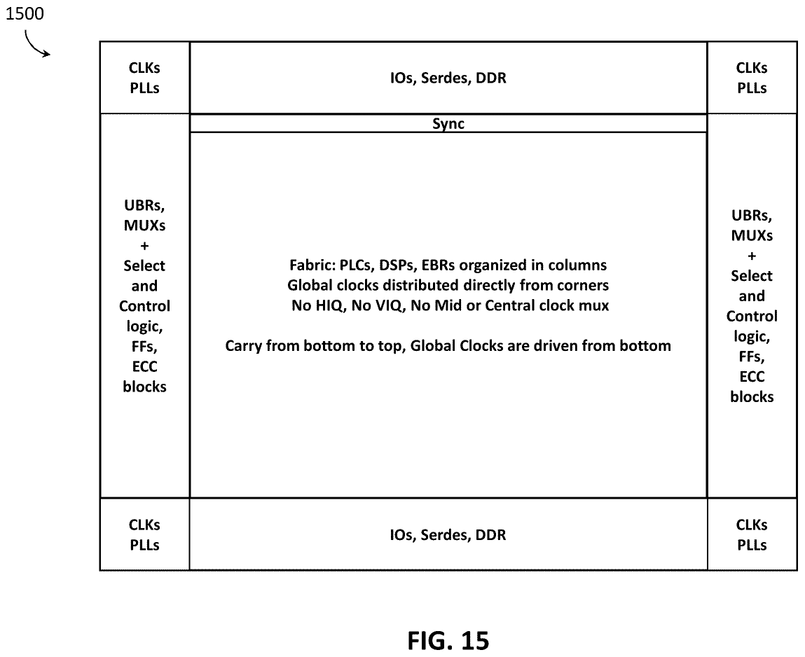

FIG. 15 illustrates an implementation of a chip plan 1500 for IOs located on the top and bottom edges of the die. In this implementation, the carry logic may run vertically and also have columns of EBR and DSP rather than rows for best timing. The PLL's and dedicated clock inputs, DCSs, DCCs, Clk dividers, and other related circuitry is located in corners only. UBRs can be used individually or aggregated (using dedicated resources) to form large multiport memories. For connecting to the fabric, a CIB will be added to the end of each PLC, CIB row.

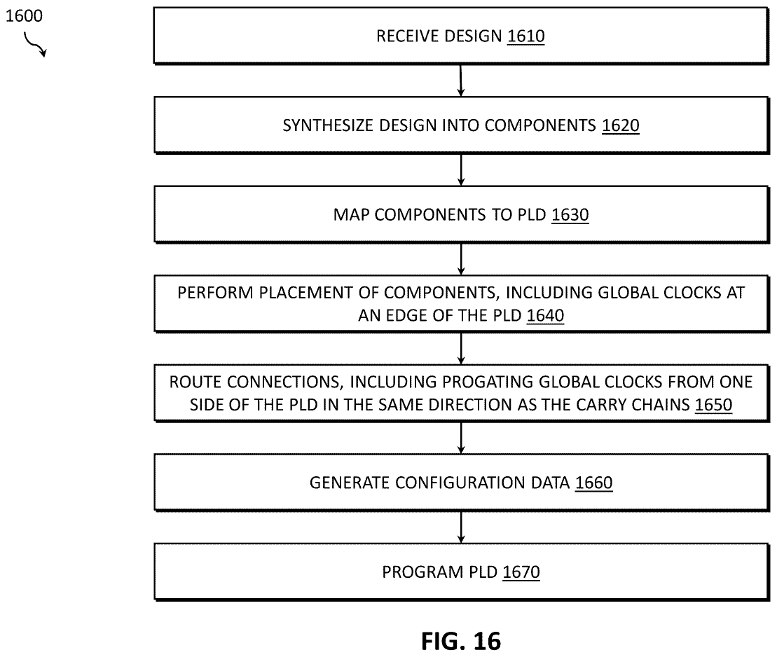

FIG. 16 illustrates an example design process 1600 for implementing a low noise clock system on a PLD, such as previously described with reference to FIGS. 1-15. For example, the process 1600 may be performed by system 130 running software to configure PLD 100. In some implementations, the various files and information referenced in process 1600 may be stored, for example, in one or more databases and/or other data structures in memory 134, machine readable medium 136, and/or other location.

In operation 1610, the system (e.g., system 130) receives a user design that specifies the desired functionality of the PLD (e.g., PLD 100). For example, the user may interact with system 130 (e.g., through user input device 137 and hardware description language (HDL) code representing the design) to identify various features of the user design (e.g., high level logic operations, hardware configurations, and/or other features). In some embodiments, the user design may be provided in a register transfer level (RTL) description (e.g., a gate level description). System 130 may perform one or more rule checks to confirm that the user design describes a valid configuration of PLD 100. For example, system 130 may reject invalid configurations and/or request the user to provide new design information as appropriate.

In operation 1620, system 130 synthesizes the design to create a netlist (e.g., a synthesized RTL description) identifying an abstract logic implementation of the user design as a plurality of logic components (e.g., also referred to as netlist components). In some embodiments, the netlist may be stored in Electronic Design Interchange Format (EDIF) in a Native Generic Database (NGD) file.

In some implementations, synthesizing the design into a netlist in operation 1620 may include converting (e.g., translating) the high-level description of logic operations, hardware configurations, and/or other features in the user design into a set of PLD components (e.g., logic blocks 104, logic cells 200, and other components of PLD 100 configured for logic, arithmetic, or other hardware functions to implement the user design) and their associated interconnections or signals. Depending on implementations, the converted user design may be represented as a netlist.

In some implementations, synthesizing the design into a netlist in operation 1620 may further involve performing an optimization process on the user design (e.g., the user design converted/translated into a set of PLD components and their associated interconnections or signals) to reduce propagation delays, consumption of PLD resources and interconnections, and/or otherwise optimize the performance of the PLD when configured to implement the user design. Depending on the implementation, the optimization process may be performed on a netlist representing the converted/translated user design. Depending on the implementation, the optimization process may represent the optimized user design in a netlist (e.g., to produce an optimized netlist).

In some implementations, the optimization process may include optimizing certain instances of a logic gate feeding a multiplexer which, when a PLD is configured to implement the user design, would occupy multiple levels of configurable PLD components (e.g., logic cells 200 and/or logic blocks 104) in a cascaded arrangement. For example, as further described herein, the optimization process may include absorbing the multiplexer into the PLD component (e.g., logic cell 200 and/or logic block 104) associated with the logic gate when a certain instance of a logic gate feeding a multiplexer is identified from the user design, such that the logic gate and the multiplexer will no longer be cascaded in multiple levels of configurable PLD components when implemented.

In operation 1630, the system 130 performs a mapping process that identifies components of the PLD 100 that may be used to implement the user design. In this regard, the system 130 may map the optimized netlist (e.g., stored in operation 320 as a result of the optimization process) to various types of components provided by PLD 100 (e.g., logic blocks 104, logic cells 200, embedded hardware, and/or other portions of PLD 100) and their associated signals (e.g., in a logical fashion, but without yet specifying placement or routing). In some implementations, the mapping may be performed on one or more previously-stored NGD files, with the mapping results stored as a physical design file (e.g., also referred to as an NCD file). In some implementations, the mapping process may be performed as part of the synthesis process in operation 1620 to produce a netlist that is mapped to PLD components.

In operation 1640, the system 130 performs a placement process to assign the mapped netlist components to particular physical components residing at specific physical locations of the PLD 100 (e.g., assigned to particular logic cells 200, logic blocks 104 and/or other physical components of PLD 100), and thus determine a layout for the PLD 100. In some implementations, the placement may be performed on one or more previously-stored NCD files, with the placement results stored as another physical design file. In various implementations, the placement of components includes placing global clocks at an edge of the PLD 100, such as illustrated in FIGS. 6, 11 and 15.

In operation 1650, the system 130 performs a routing process to route connections (e.g., using routing resources 180) among the components of PLD 100 based on the placement layout determined in operation 1640 to realize the physical interconnections among the placed components. In some implementations, the routing may be performed on one or more previously-stored NCD files, with the routing results stored as another physical design file. The routing may include propagating global clocks from one side of the PLD 100 in the same direction as the carry chains.

Thus, following operation 1650, one or more physical design files may be provided which specify the user design after it has been synthesized (e.g., converted and optimized), mapped, placed, and routed for PLD 100 (e.g., by combining the results of the corresponding previous operations). In operation 1660, system 130 generates configuration data for the synthesized, mapped, placed, and routed user design. In operation 1670, the system 130 configures the PLD 100 with the configuration data by, for example, loading a configuration data bitstream into the PLD 100 over connection 140.

Where applicable, various implementations provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

In this regard, various implementations described herein may be implemented with various types of hardware and/or software and allow for significant improvements in, for example, performance and space utilization.

Software in accordance with the present disclosure, such as program code and/or data, can be stored on one or more non-transitory machine-readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

The implementations described above illustrate but do not limit the invention. It should also be understood that numerous modifications and variations are possible in accordance with the principles of the present invention. Accordingly, the scope of the invention is defined only by the following claims.

What is claimed is:

1. A method comprising:
configuring a programmable logic device (PLD) comprising a fabric of programmable logic blocks arranged in a plurality of regions;
routing data carry chains in a first direction across the fabric to each of the plurality of regions;
placing global clock circuitry at a first edge of the PLD; and
routing the global clock to a corresponding first edge of each region via a global clock trunk and a plurality of clock branches, the global clock trunk propagating the global clock signal in across the fabric and each region, in the same direction as the data carry chains.

2. The method of claim 1, wherein a global clock delay at each region increases as the clock signal propagates away from the first edge.

3. The method of claim 1, further comprising at least one regional clock propagating a regional clock signal to one or more of the regions.

4. The method of claim 1, further comprising adding delay elements to the global clock trunk and/or plurality of clock branches to tune the clock signal delay for each region.

5. The method of claim 1, wherein the plurality of regions are arranged in a plurality of rows and a plurality of columns and wherein the global clock trunk is placed between two rows of regions.

6. The method of claim 1, wherein the plurality of regions are arranged in a plurality of rows and a plurality of columns and wherein the global clock trunk is placed along an outer edge of a row and/or column.

7. The method of claim 6, wherein the global clock trunk is a first global clock trunk of a plurality of clock trunks; and wherein the method further comprises placing a second clock trunk of the plurality of clock trunks outside further comprising a plurality of global clock trunks, is placed along an outer edge of a row and/or column, opposite the first global clock trunk.

8. The method of claim 7, further comprising, placing pulse circuitry connecting a first branch of the first global clock trunk at a first region to a second branch of the second global clock trunk at an adjacent region.

9. The method of claim 8, wherein the pulse circuitry is configured to facilitate global clock propagation through the regions corresponding to a meandering data carry chain.

10. The method of claim 1, wherein global clock propagation delay is less than carry chain propagation delay and less than general purpose routing propagation delay for data signals.

11. A programmable logic device (PLD) comprising:
a fabric of programmable logic blocks arranged in a plurality of regions;
data carry chain routing configured to propagate in a first direction across the fabric to each of the plurality of regions;
global clock circuitry located at a first edge of the PLD; and
global clock routing comprising a global clock trunk and a plurality of global clock branches configured to propagate a global clock signal from the first edge of the PLD to a corresponding first edge of each region, wherein the global clock trunk propagates the global clock signal across the fabric and each region, in the same direction as the data carry chains.

12. The PLD of claim 11, wherein a global clock delay at each region increases as the clock signal propagates away from the first edge.

13. The PLD of claim 11, further comprising at least one regional clock propagating a regional clock signal to one or more of the regions.

14. The PLD of claim 11, wherein the global clock trunk and/or plurality of global clock branches further comprises delay elements configurable to tune the global clock signal delay for one or more of the regions.

15. The PLD of claim 11, wherein the plurality of regions are arranged in a plurality of rows and a plurality of columns and wherein the global clock trunk is placed between two rows of regions.

16. The PLD of claim 11, wherein the plurality of regions are arranged in a plurality of rows and a plurality of columns and wherein the global clock trunk is placed along an outer edge of a row and/or column.

17. The PLD of claim 16, wherein the global clock trunk is a first global clock trunk of a plurality of clock trunks; and wherein the PLD further comprises a second clock trunk of the plurality of clock trunks placed along an outer edge of a row and/or column, opposite the first global clock trunk.

18. The PLD of claim 17, further comprising, pulse circuitry configured to connect a first branch of the first global clock trunk at a first region to a second branch of the second global clock trunk at an adjacent region.

19. The PLD of claim 18, wherein the pulse circuitry is configured to facilitate global clock propagation through the regions corresponding to a meandering data carry chain.

20. The PLD of claim 11, wherein global clock propagation delay is less than carry chain propagation delay and less than general purpose routing propagation delay for data signals.
